(19) United States
(12) Patent Application Publication
(10) Pub. No.: US 2014/0265783 A1
(43) Pub. Date: Sep. 18, 2014

(54) SYNCHRONISATION DEVICE FOR A DRAWER

(71) Applicant: Julius Blum GmbH, Hoechst (AT)

(72) Inventors: Christian HAUER, Hoerbranz (AT); Markus IRGANG, Goetzis (AT)

(73) Assignee: Julius Blum GmbH, Hoechst (AT)

(21) Appl. No.: 14/294,375

(22) Filed: Jun. 3, 2014

Related U.S. Application Data
(63) Continuation of application No. PCT/AT2012/000319, filed on Dec. 21, 2012.

(30) Foreign Application Priority Data
Dec. 27, 2011 (AT) 1892/2011

(51) Int. Cl. A47B 88/12; F16H 19/04

(52) U.S. Cl. CPC A47B 88/12; F16H 19/04
USPC 312/331; 74/30

(57) ABSTRACT

A synchronisation device stabilizes the running behavior of a drawer in a furniture body, and includes a synchronising rod. The synchronising rod has a longitudinal axis, and the device further includes two tracking gearwheels that engage in two racks of a rail pull-out guide. A rotary movement of the two tracking gearwheels is coupled to a rotary movement of the synchronising rod, and the rotational axes of all tracking gearwheels are spaced at a distance from the longitudinal axis of the synchronising rod.

The invention concerns a synchronisation device with a synchronisation rod for stabilising the running behaviour of a drawer in a furniture carcass, wherein the synchronisation rod has a longitudinal axis, and two spur gears which engage into two racks of a rail extension guide, wherein a rotary movement of the two spur gears is coupled to a rotary movement of the synchronisation rod.

The invention further concerns a drawer having a synchronisation device in accordance with one of the described embodiments and an article of furniture having at least one such drawer.

Such synchronisation devices are already known and are disclosed̂, for example, in WO 2011/075753 and EP 1 036 526 B1.

The object of the invention is to provide a synchronisation device which is improved over the state of the art for stabilising the running behaviour of a drawer in a furniture carcass.

That object is attained by a synchronisation device having the features of claim 1.

The fact that the axes of rotation of all spur gears are arranged at a spacing relative to the longitudinal axis of the synchronisation rod means that there is a local displacement between the spur gears and the synchronisation rod.

That gain in space makes it possible, for example, that an ejection device for ejecting the drawer can be arranged behind the drawer. Thus, this synchronisation device is suitable both for drawers which are driven with an ejection device and also for drawers which do not have an ejection device, whereby the synchronisation device is suitable for universal applications.

Further advantageous configurations of the invention are recited in the appendant claims.

In a preferred embodiment, it can be provided that the axis of rotation of the synchronisation rod, in the assembled condition of the synchronisation device, is closer to a drawer rear wall of a mounted drawer than the axes of rotation of the spur gears. By virtue of that feature it is possible to provide that the drawer can be fully extended without the spur gears becoming trackingly disengaged at the front (at the operator side).

Desirably, the axis of rotation of the synchronisation rod in the assembled condition of the synchronisation device and the axes of rotation of the spur gears are arranged on a substantially horizontal plane. The configuration on a substantially horizontal plane makes it possible to achieve a compact structure.

In specific terms, protection is also claimed for a drawer having a synchronisation device for stabilising the running behaviour of the drawer in a furniture carcass in accordance with at least one of the described embodiments.

Protection is also claimed for an article of furniture having at least one drawer with a synchronisation device for stabilising the running behaviour of the drawer in a furniture carcass of the article of furniture in accordance with at least one of the described embodiments.

Further details and advantages of the present invention are described in greater detail hereinafter by means of the specific description with reference to the embodiments by way of example illustrated in the drawing in which:

FIG. 1 shows a perspective view of an article of furniture having three drawers,

FIG. 2 shows a side view of a drawer having a rail extension guide and an ejection device,

FIG. 3 shows a perspective view from below and from the rear of a drawer with a rail extension guide and an ejection device,

FIG. 4 shows a perspective detail view of a synchronisation device at the rear side of a drawer,

FIGS. 5a-5d show perspective views of a synchronisation device at a rack,

FIGS. 6a, 6b show perspective views of a variant of a synchronisation device at a rack, and

FIGS. 7a, 7b show perspective views of a further variant of a synchronisation device at a toothed rack.

FIG. 1 shows a perspective view of an article of furniture 110. In this case, the article of furniture 110 has a furniture carcass 103 with three drawers 101 arranged therein.

In this preferred embodiment, the article of furniture 110 has an ejection device 104 for the drawers 101, as can be seen from FIG. 2. When the ejection device 104 ejects the drawer 101, that drawer 101 moves out of the furniture carcass 103 on the rail extension guide 105. In this case, provided at the rear side of the drawer 101 is the synchronisation device 100 for stabilising the running behaviour of the drawer 101 in the furniture carcass 103.

FIG. 3 shows a perspective rear view of a drawer 101 from below. In this case, provided at the rear side 102 of the drawer 101 is on the one hand the synchronisation device 100, while on the other hand there is the ejection device 104 which can eject the drawer 101—when the drawer 101 is fully retracted into the article of furniture 110 (not shown here). Usually the ejection device 104 is fixed to a furniture carcass 103 (not shown here) and does not move with the drawer 101. Naturally it can equally well be envisaged that the ejection device 104 is to be fixed to the rear side 102 of the drawer 101 and thereby the ejection device 104 can be caused to move together with the drawer 101.

In this respect, it is particularly preferably provided that the two racks 11 and 12 are connected to the carcass rails 106 of the rail extension guide 105.

As can be clearly seen from this view, the synchronisation rod 1 in this preferred embodiment is provided behind the drawer 101 and in addition the synchronisation rod 1 of the synchronisation device 100 is provided at the rear wall 102 of the drawer 101.

The drawer 101 can be ejected by way of the ejection device 104. In this respect, it is preferably provided that the synchronisation rod 1 of the synchronisation device 100 is arranged between the rear wall 102 of the drawer 101 and the ejection device 104.

To stabilise the running behaviour of the drawer 101, the rail extension guides 105 each have a respective rack 12 and 22 into which engage two tracking spur gears 11 and 21 (not shown). The two spur gears 11 and 21 are driven by way of the synchronisation rod 1 which extends transversely along the rear side 102 of the drawer 101.

The spur gears 11 and 21 cannot be seen in the FIG. 3, as they are disposed under the covers 2 and 3 of the synchronisation device 100.

FIG. 4 shows a perspective view of the synchronisation rod 1 of the synchronisation device 100 on which a synchronisation rod gear 13 is axially provided.

It can clearly be seen from this view that the spur gear 11 is provided in a displaced relationship relative to the synchronisation rod gear 13 and thus in displaced relationship with the synchronisation rod 1.

FIGS. 5a-5d show perspective views of both ends of the synchronisation device 100 for stabilising the running behaviour of a drawer 101 (not shown here) in a furniture carcass 103 (not shown here). It can be clearly seen from the FIGS. 5a-5d views that there is a spacing X between the longitudinal axis C of the synchronisation rod 1 and the two axes of rotation A and B of the spur gears 11 and 21. That spacing X results in a displacement of the two spur gears 11 and 21 in their corresponding racks 12 and 22 relative to the longitudinal axis C of the synchronisation rod 1.

In synchronisation devices belonging to the state of the art, the spur gears are themselves usually fixed non-rotatably to the synchronisation rod and thus the axes of rotation of the spur gears are disposed on the same axis—therefore the longitudinal axis C of the synchronisation rod 1—and are therefore not disposed at a spacing relative to that longitudinal axis C.

In this preferred embodiment, that is implemented by a transmission gear 14 and 24 respectively corresponding to a synchronisation rod gear 13 and 23 respectively provided non-rotatably on the synchronisation rod 1.

It can further be clearly seen from FIGS. 5a-5d, that the axis of rotation C of the synchronisation rod 1, in the assembled condition of the synchronisation device 100, and the axes of rotation A and B of the spur gears 11 and 21 are arranged on a substantially horizontal plane.

That displacement of the axes of rotation A and B relative to the longitudinal axis C of the synchronisation rod 1 can naturally also be achieved in another way, as is shown for example in FIGS. 6a and 6b and FIGS. 7a and 7b respectively.

It can be clearly seen specifically from the views in FIGS. 5c and 5d that only one respective spur gear 11 and 21 is provided on the synchronisation device 100 both at its left-hand side and also at its right-hand side.

It can also be clearly seen here that only one single rack 12 and 22 respectively is provided in the synchronisation device 100 both at its left-hand side and also at its right-hand side.

FIGS. 6a and 6b show a variant of a synchronisation device 100 in which the synchronisation rod gears 13 and 23 (only 13 is shown) engage into the spur gears 11 and 21 (only 11 is shown). That direct coupling of the synchronisation gears 13 and 23 to the spur gears 11 and 21 involves a change in the direction of rotation, that is to say the synchronisation rod gears 13 and 23 and thus the synchronisation rod 1 rotate in opposite relationship to the spur gears 11 and 21. In regard to the displacement of the axes of rotation A and B of the spur gears 11 and 21 relative to the longitudinal axis C of the synchronisation rod 1, the description relating to FIGS. 5a-5d correspondingly applies here.

A further variant of a synchronisation device 100 is shown in FIGS. 7a and 7b, in which a torque transmission from the synchronisation rod 1 to the spur gears 11 and 21 is by effected by way of a belt drive 30. In this preferred embodiment, the belt drive 30 is in the form of a toothed belt drive 31. It could naturally also be envisaged that the belt drive 30 could be in the form of a V-belt drive or similar. In regard to the displacement of the axes of rotation A and B of the spur gears 11 and 21 relative to the longitudinal axis C of the synchronisation rod 1, the description relating to FIGS. 5a through 5d correspondingly applies here.

In all shown embodiments, there is a change in the direction of rotation between the spur gears 11 and 21 and the synchronisation rod 1. It could naturally also be envisaged that the direction of rotation is not changed, which could be easily effected by for example using an additional gear.

1. A synchronisation device for stabilising the running behaviour of a drawer in a furniture carcass, comprising:
a synchronisation rod, wherein the synchronisation rod has a longitudinal axis, and
two spur gears which engage into two racks of a rail extension guide, wherein a rotary movement of the two spur gears is coupled to a rotary movement of the synchronisation rod,
wherein the axes of rotation of all spur gears are at a spacing relative to the longitudinal axis of the synchronisation rod.

2. The synchronisation device according to claim 1, wherein at least one respective belt drive is adapted for transmission of the rotary movement from the synchronisation rod to the spur gears.

3. The synchronisation device according to claim 2, wherein the belt drive is in the form of a toothed belt drive.

4. The synchronisation device according to claim 2, wherein the belt drive is in the form of a V-belt drive.

5. The synchronisation device according to claim 1, wherein provided at both ends of the synchronisation rod is a respective synchronisation rod gear which is non-rotatable relative thereto and the rotary movement of which is coupled to the rotary movement of the two spur gears.

6. The synchronisation device according to claim 5, wherein the synchronisation rod gears engage into the spur gears.

7. The synchronisation device according to claim 5, wherein at least one respective coupled transmission gear is adapted for the transmission of the rotary movement from the synchronisation rod gears to the spur gears.

8. The synchronisation device according to claim 7, wherein the transmission gears are provided axially with respect to the axis of rotation of the spur gears.

9. The synchronisation device according to claim 1, wherein the axis of rotation of the synchronisation rod in the assembled condition of the synchronisation device is closer to a drawer rear wall of an assembled drawer than the axes of rotation of the spur gears.

10. The synchronisation device according to claim 1, wherein the axis of rotation of the synchronisation rod in the assembled condition of the synchronisation device and the axes of rotation of the spur gears are arranged on a substantially horizontal plane.

11. The synchronisation device according to claim 1, wherein only one respective spur gear is provided on the synchronisation device both at its left-hand side and also at its right-hand side.

12. The synchronisation device according to claim 1, wherein only one respective rack is provided on the synchronisation device both at its left-hand side and also at its right-hand side.

13. The synchronisation device according to claim 1, wherein the two racks are connected with carcass rails of the rail extension guide.

14. A drawer having a synchronisation device for stabilising the running behaviour of the drawer in a furniture carcass according to claim 1.

15. The drawer according to claim 14, wherein the synchronisation rod of the synchronisation device is provided behind the drawer.

16. The drawer according to claim 14, wherein the synchronisation rod of the synchronisation device is provided at the drawer rear wall of the drawer.

17. An article of furniture comprising at least one drawer according to claim 14.

18. An article of furniture according to claim 17, wherein the article of furniture has an ejection device for ejection of the drawer.

19. The article of furniture according to claim 18, wherein the synchronisation rod of the synchronisation device is between the drawer rear wall of the drawer and the ejection device.
